(19) United States
(12) Patent Application Publication
(10) Pub. No.: US 2003/0218884 A1
(43) Pub. Date: Nov. 27, 2003

(54) Vehicle headlight equipped with gas-discharge lamp

(76) Inventor: Si Yung Kim, Incheon-shi (KR)

Correspondence Address: STAAS & HALSEY LLP, SUITE 700, 1201 NEW YORK AVENUE, N.W., WASHINGTON, DC, 20005, US

(21) Appl. No.: 10/323,741

(22) Filed: Dec. 20, 2002

(30) Foreign Application Priority Data
May 24, 2002 (KR) 2002-15885

(51) Int. Cl. B60Q 1/06

(52) U.S. Cl. 362/508; 362/526; 362/286

(57) ABSTRACT

Disclosed herein is a vehicle headlight equipped with a gas-discharge lamp, which is designed such that a high beam mode or a low beam mode is selectively operated by controlling a position of the gas-discharge lamp using a magnetic force, thus making the interior construction of the headlight compact, in addition to the prevention of frequent malfunction of the headlight. The headlight is provided with a lamp control means controlling a position of a bobbin in a housing to selectively operate the low beam mode or the high beam mode. The lamp control means includes a return spring provided in the housing to elastically bias the bobbin forward. A magnet assembly is installed in a rear portion of the housing in such a way as to be adjacent to a rear end of the bobbin. A solenoid is wound around a rear portion of the bobbin and cooperates with the magnet assembly to move the bobbin and a bulb rearward when electric power is applied.

### BACKGROUND OF THE INVENTION

1. Field of the Invention

The present invention relates generally to vehicle headlights, and more particularly, to a vehicle headlight equipped with a gas-discharge lamp, which is operated in a high beam mode or a low beam mode using a single light source, that is, a single gas-discharge lamp.

2. Description of the Prior Art

As well known to those skilled in the art, a headlight is mounted on the front of a vehicle to ensure sufficient field of view of a driver when driving the vehicle at night. The headlight must have a luminous intensity specified by law without obstructing the vision of oncoming drivers. Thus, the headlight is designed to selectively irradiate a high beam or a low beam by the operation of a column switch. In this case, the high beam functions to provide long-range illumination, whereas the low beam functions to provide short-range illumination so as to prevent the light beams from obstructing the vision of oncoming drivers.

Such a conventional headlight includes a halogen lamp or a gas-discharge lamp, a reflecting mirror, and a lens. The reflecting mirror is provided at the rear portion of the lamp, and is coated with aluminum. The lens is used to reflect light beams to the front of a vehicle, with a predetermined magnifying power. Since the halogen lamp used in the headlight is provided with two filaments, that is, a filament for irradiating a high beam and a filament for irradiating a low beam, a high beam mode or a low beam mode is selectively operated according to the operation of a driver.

However, the conventional headlight with such a halogen lamp has a problem that two filaments are provided in the halogen lamp, so its construction is complicated and its manufacturing cost is undesirably high.

In order to solve the problem, there has been proposed a variable gas-discharge lamp for headlights, an application for registration of utility model of which was filed by the inventor of the present invention, together with a request for technical evaluation. Registration has been granted to the utility model application (Korean U.M. Registration No. 0223398) and a decision ruling that the registration is valid was made on Sep. 19, 2001.

Referring to FIG. 1, the variable gas-discharge lamp 1 for headlights, which is disclosed in Korean U.M. Registration No. 0223398, includes a reflecting mirror 3 and a mirror control means. The arc-shaped reflecting mirror 3 surrounds the lower portion of a bulb 2. The mirror control means functions to incline the reflecting mirror 3 downwards at a predetermined angle of inclination and return the inclined reflecting mirror 3 to its original position. The mirror control means includes a solenoid 5, a lever 6, a support pin 7, and a spring 8. The solenoid 5 is mounted to the lower portion of a mounting plate 4 to which the bulb 2 of the gas-discharge lamp 1 is fixedly mounted. The lever 6 is rotated by the solenoid 5, and externally supports a projecting part which downwardly extends from a center of a rear end of the reflecting mirror 3. The U-shaped support pin 7 is mounted, at its both ends, to the solenoid 5, and is connected, at its center portion, to the upper portion of the projecting part of the reflecting mirror 3. The spring 8 is mounted to the support pin 7, and elastically supports the lower portion of the reflecting mirror 3.

When electric power is applied to the solenoid 5, the projecting part of the reflecting mirror 3 is pulled backward, so that the front portion of the reflecting mirror 3 is inclined downwards, thus allowing the headlight to irradiate a high beam. On the contrary, when electric power is shut off, the front portion of the reflecting mirror 3 moves upwardly to be returned to its original position by the restoring force of the spring 8, thus allowing the headlight to irradiate a low beam. That is, a high beam mode or a low beam mode is selectively operated using a single gas-discharge lamp 1 by controlling an inclination angle of the reflecting mirror 3.

However, another conventional headlight with the variable gas-discharge lamp has a problem that the mirror control means for controlling an inclination angle of the reflecting mirror 3 is complicated in construction, and the headlight frequently malfunctions due to repeated operation of the reflecting mirror 3.

### SUMMARY OF THE INVENTION

Accordingly, the present invention has been made keeping in mind the above problems occurring in the prior art, and an object of the present invention is to provide a vehicle headlight equipped with a gas-discharge lamp, which is designed such that a reflecting mirror is fixed in position, and a high beam mode or a low beam mode is selectively operated by controlling a position of the gas-discharge lamp using a magnetic force, thus making the interior construction of the headlight compact, in addition to preventing frequent malfunctioning of the headlight.

In order to accomplish the above object, the present invention provides a vehicle headlight, including a gas-discharge lamp having a bobbin and a bulb axially provided at a front end of the bobbin, a hemispherical reflecting mirror arranged to surround a rear portion of the bulb and reflecting light beams forwards, a housing installed at a center portion of the hemispherical reflecting mirror in such a way that the bobbin of the gas-discharge lamp is provided in the housing to be slidable in an axial direction, and a lamp control means controlling a position of the bobbin in the housing to selectively operate a low beam mode or a high beam mode, wherein the lamp control means includes a return spring provided in the housing to elastically bias the bobbin forward, a magnet assembly installed in a rear portion of the housing in such a way as to be adjacent to a rear end of the bobbin, and a solenoid wound around a rear portion of the bobbin and cooperating with the magnet assembly to move the bobbin and the bulb rearward when electric power is applied.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a variable gas-discharge lamp for headlights according to prior art;

FIG. 2 is a sectional view showing the interior of a vehicle headlight equipped with a gas-discharge lamp according to an embodiment of the present invention;

FIG. 3 is an exploded perspective view showing the gas-discharge lamp and a lamp control means included in the headlight according to the present invention;

FIG. 4 is a sectional view of the gas-discharge lamp and the lamp control means included in the headlight according to the present invention; and

FIGS. 5 and 6 are sectional views showing the operation of the gas-discharge lamp according to the present invention.

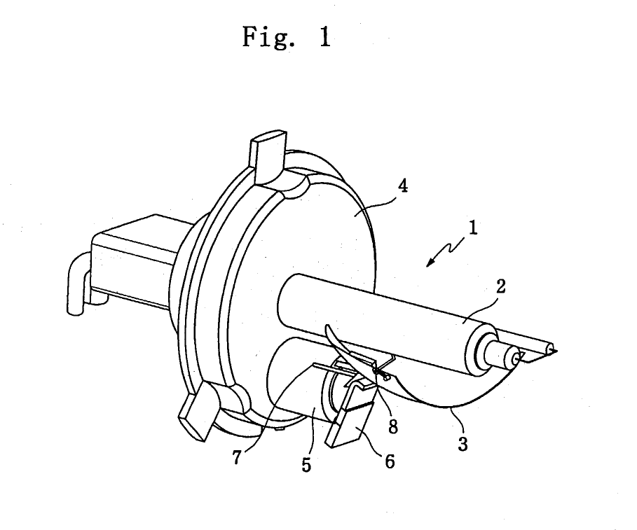

### DESCRIPTION OF THE PREFERRED EMBODIMENTS

Reference should now be made to the drawings, in which the same reference numerals are used throughout the different drawings to designate the same or similar components.

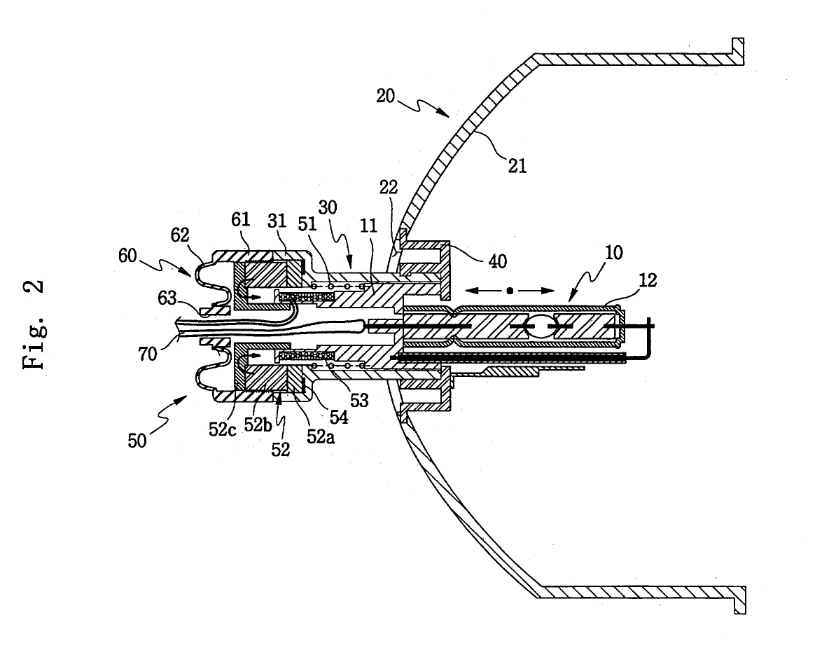

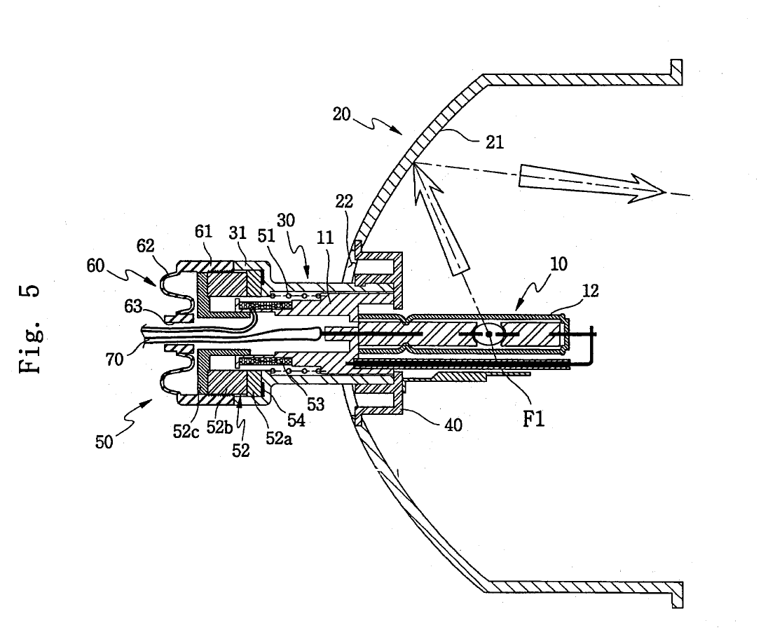

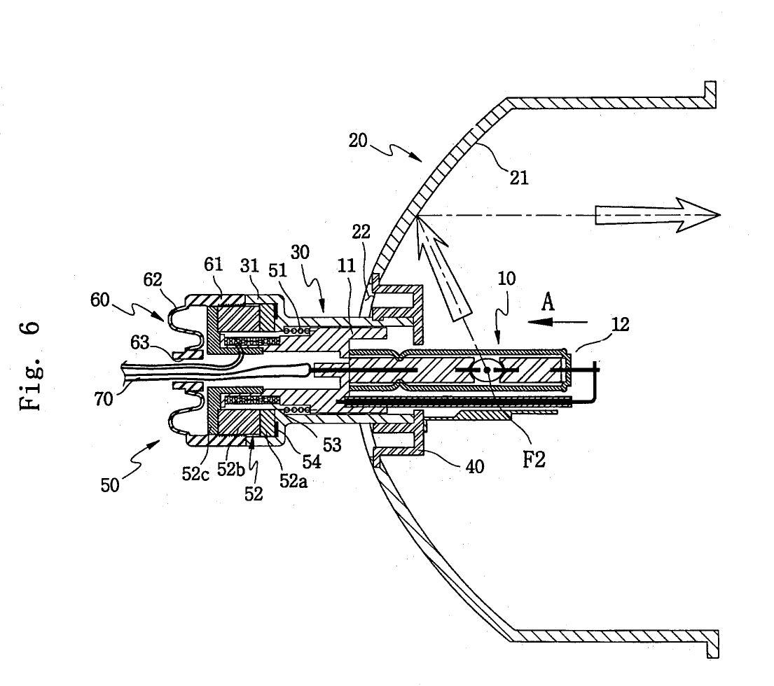

FIGS. 2 to 4 show the construction of the vehicle headlight according to an embodiment of the present invention. FIGS. 5 and 6 show the operation of the vehicle headlight according to the present invention.

As shown in FIG. 2, the vehicle headlight according to the present invention includes a gas-discharge lamp 10. The gas-discharge lamp 10 is provided with a bobbin 11 and a bulb 12. A hemispherical reflecting mirror 20 is arranged to surround the rear portion of the bulb 12. A housing 30 is installed to the hemispherical reflecting mirror 20 in such a way that the bobbin 11 of the gas-discharge lamp 10 is provided in the housing 30 to be slidable in an axial direction. A lamp control means 50 controls a position of the bobbin 11 in the housing 30 to selectively operate a low beam mode or a high beam mode.

The gas-discharge lamp 10 includes the bobbin 11 and the bulb 12. Power supply wires 70 are connected to the bobbin 11 to supply external electric power to the headlight. The bulb 12 is axially provided at the front end of the bobbin 11. In this case, the bulb 12 of the gas-discharge lamp 10 is arranged at the center portion of the hemispherical reflecting mirror 20 in such a way as to be almost parallel to an irradiating direction of a light beam.

The hemispherical reflecting mirror 20 has a hemispherical shape to have a concave reflecting surface 21. A mounting hole 22 is formed at the center portion of the reflecting mirror 20 so that the bulb 12 of the gas-discharge lamp 10 is installed at the center portion of the reflecting mirror 20 through the mounting hole 22.

The housing 30 has a hollow cylindrical shape so that the bobbin 11 of the gas-discharge lamp 10 is slidable in an axial direction in the housing 30. The front portion of the housing 30 is inserted into the hemispherical reflecting mirror 20 through the mounting hole 22 which is formed at the center portion of the reflecting mirror 20, and then is firmly fixed to the reflecting mirror 20 by means of a support bracket 40. Thus, the bulb 12 of the gas-discharge lamp 10 is positioned inside the reflecting mirror 20. The housing 30 is provided at its rear portion with an expanding part 31 which has an increased diameter so that a magnet assembly 52 which will be described later herein in detail is installed in the housing 30.

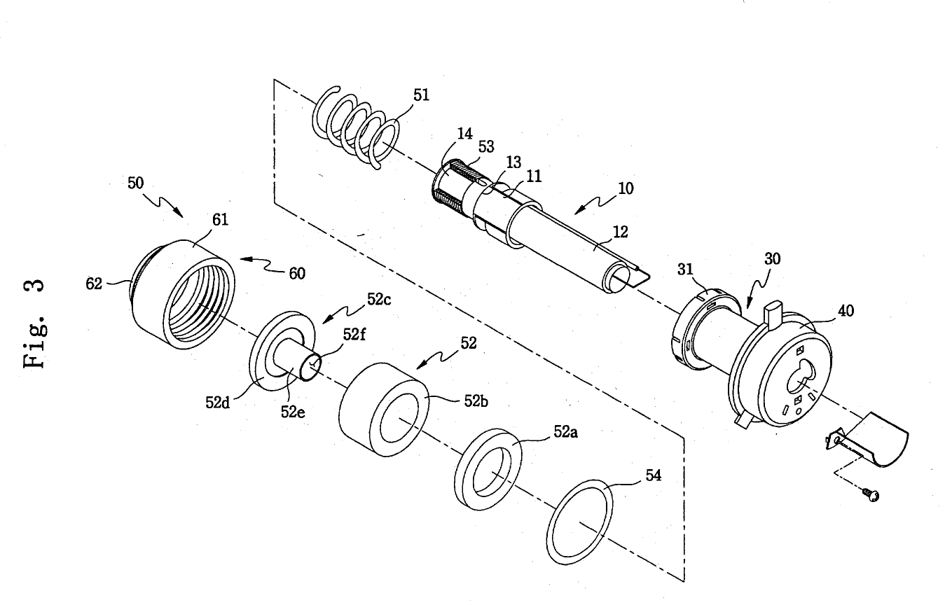

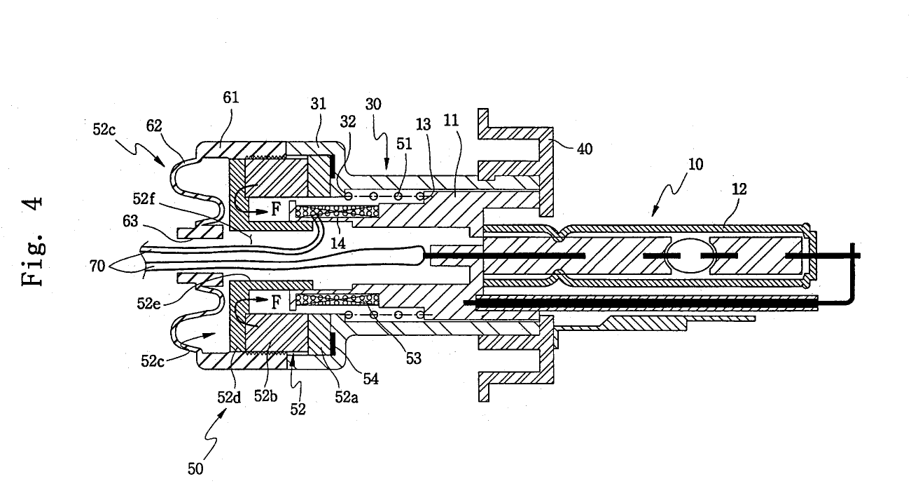

As shown in FIGS. 3 and 4, the lamp control means 50 functions to selectively operate a high beam mode or a low beam mode by the interaction between the magnet assembly 52 and the solenoid 53. The lamp control means 50 includes a return spring 51, the magnet assembly 52, and the solenoid 53. The return spring 51 is provided in the housing 30 to elastically bias the bobbin 11 forward. The magnet assembly 52 is installed in the rear portion of the housing 30 in such a way as to be adjacent to the rear end of the bobbin 11. The solenoid 53 is wound around the rear portion of the bobbin 11, and cooperates with the magnet assembly 52 when electric power is applied.

The return spring 51 comprises a coiled spring to surround the bobbin 11 while maintaining a predetermined gap between the return spring 51 and the bobbin 11. The return spring 51 is stopped, at its front end, by a middle step 13 of the bobbin 11, and at its rear end, by a step 32 formed at the inner surface of the housing 30. The return spring 51 is thus supported between two steps 13 and 32 formed at the midsection of the bobbin 11 and the inner surface of the housing 30. In a normal state, the bobbin 11 is elastically biased forward in the housing 30 by the return spring 51. Preferably, the return spring 51 is made of stainless steel which is not magnetized and maintains a predetermined elastic force for a lengthy period of time.

The magnet assembly 52 includes a metal cover 52a which is set in the rear portion of the housing 30. In this case, a packing 54 is interposed between the metal cover 52a and the housing 30. A magnet 52b is attached to the metal cover 52a by a magnetic force. A metal bracket 52c is attached to a rear surface of the magnet 52b, and induces a line of magnetic force to the solenoid 53.

The metal cover 52a has the shape of a ring having a predetermined thickness, and is set in the expanding part 31, which is provided at the rear portion of the housing 30, in the manner of force fitting. The packing 54 is interposed between the metal cover 52a and the expanding part 31 of the housing 30, thus preventing the housing 30 from being damaged or broken when setting the metal cover 52a in the expanding part 31 in the manner of force fitting.

The magnet 52b has a ring shape, and is attached, at its front surface, to the metal cover 52a which is set in the expanding part 31 of the housing 30, by a magnetic force. Thus, the magnet 52b is arranged such that it is received, at its front portion, in the expanding part 31 of the housing 30 and is exposed, at its rear portion, to the outside of the expanding part 31 of the housing 30.

As described above, the metal bracket 52c functions to induce a line of magnetic force of the magnet 52b to the solenoid 53. The metal bracket 52c includes a disc-shaped base part 52d and a magnetic force line inducing part 52e. The base part 52d is attached to the rear surface of the magnet 52b which is exposed to the outside of the housing 30, by a magnetic force. The magnetic force line inducing part 52e is forwardly projected from the center portion of the base part 52d so as to face the solenoid 53, and is spaced apart from the inner surface of the hollow magnet 52b at a regular interval. Thus, the line of magnetic force is induced from the magnet 52b to the solenoid 53, that is, in a direction of the arrow F shown in FIG. 4. Further, a hollow part 52f is axially formed in the magnetic force line inducing part 52e so that the power supply wires 70 pass through the hollow part 52f of the magnetic force line inducing part 52e. The power supply wires 70 are connected to both the solenoid 53 and the gas-discharge lamp 10.

Further, a dust cover 60 made of rubber covers the rear portion of the magnet 52b and the metal bracket 52c, thus preventing impurities from penetrating into the headlight. The dust cover 60 includes a ring-shaped cover frame 61 which surrounds the outer surface of the rear portion of the magnet 52b. An elastic cover part 62 is mounted to the rear portion of the cover frame 61 in such a way as to be integrated with the cover frame 61 to have elasticity. The cover frame 61 is designed such that its inner surface is threaded, like a nut, thus preventing water from penetrating into the headlight. A wire passing hole 63 is formed along the central axis of the elastic cover part 62 in such a way as to correspond to the hollow part 52f of the metal bracket 52c.

The solenoid 53 is wound around the rear portion of the bobbin 11, and generates a magnetic force to cooperate with the magnet 52b when electric power is applied. In order to wind the solenoid 53 around the rear-portion of the bobbin 11, a solenoid seating recess 14 is formed on the rear portion of the bobbin 11.

When electric power is applied to the solenoid 53, the solenoid 53 generates a line of magnetic force so that an attractive force is created between the solenoid 53 and the magnet 52b. At this time, the bobbin 11 which is forwardly biased by the return spring 51 slides rearwards in the axial direction. Meanwhile, when electric power is shut off, the interaction between the solenoid 53 and the magnet 52b is released, so the bobbin 11 is returned to its original position by the restoring force of the return spring 51. The power supply to the solenoid 53 is controlled by a column switch (not shown) which is typically provided at a steering shaft in front of a driver's seat.

The operation and effect of the vehicle headlight according to the present invention will be described in the following with reference to FIGS. 5 and 6.

Referring to FIG. 5, when electric power is not supplied to the solenoid 53, the bobbin 11 of the gas-discharge lamp 10 is elastically biased forward by the return spring 51. Thus, a focus F1 of the bulb 12 of the gas-discharge lamp 10 is positioned on a front portion in the hemispherical reflecting mirror 20, so the focus F1 of the bulb 12 does not coincide with a focus of the reflecting surface 21.

In such a state, when electric power is applied to the gas-discharge lamp 10, most of light beams irradiated from the bulb 12 are reflected by an area around the edge of the reflecting surface 21 of the hemispherical reflecting mirror 20, so that the headlight irradiates a low beam, which is downwardly inclined, to the front of a vehicle.

Meanwhile, when electric power is applied to the solenoid 53 by the operation of the column switch, lines of magnetic force are formed around the solenoid 53 and interact with lines of magnetic force which are formed around the magnet 52b. At this time, the two types of magnetic force lines have opposite polarities, so an attractive force is created between the solenoid 53 and the magnet 52b.

Thus, as shown in FIG. 6, the bobbin 11 provided with the solenoid 53 rearwardly slides in a direction of the arrow A while overcoming the elastic force of the return spring 51. At this time, the bulb 12 of the gas-discharge lamp 10 is also moved rearwards in the hemispherical reflecting mirror 20. In this case, the focus F2 of the bulb 12 of the gas-discharge lamp 10 is positioned at a rear portion in the hemispherical reflecting mirror .20, different from the low beam mode, thus coinciding with the focus of the reflecting surface 21.

In such a state, when electric power is applied to the gas-discharge lamp 10, most of light beams irradiated from the bulb 12 are reflected by an area around the center of the reflecting surface 21 of the hemispherical reflecting mirror 20, so that the headlight irradiate a high beam in a straight line, to the front of the vehicle.

Thereafter, when electric power is shut off by controlling the column switch, the bobbin 11 is returned to its original position in the housing 30 by the restoring force of the return spring 51. At this time, the bulb 12 of the gas-discharge lamp 10 is returned to the position for irradiating a low beam.

In a brief description, the headlight of the present invention is designed such that the hemispherical reflecting mirror 20 is fixed in position and a high beam mode or a low beam mode is selectively operated by controlling a position of the gas-discharge lamp 10 by means of the magnet assembly 52 and the solenoid 53.

As described above, the present invention provides a vehicle headlight equipped with a gas-discharge lamp, which is provided with a lamp control means controlling the position of a bobbin in a housing to selectively operate a low beam mode or a high beam mode, and including a return spring provided in the housing to elastically bias the bobbin forward, a magnet assembly installed in a rear portion of the housing in such a way as to be adjacent to a rear end of the bobbin, and a solenoid wound around a rear portion of the bobbin and cooperating with the magnet assembly to move the bobbin and a bulb rearward when electric power is applied. The headlight of the present invention is operated in a high beam mode or a low beam mode by controlling a position of the gas-discharge lamp using the interaction between the magnet assembly and the solenoid, thus having a compact interior construction. Further, the headlight of the present invention is designed such that the bobbin of the gas-discharge lamp is slightly moved in an axial direction, thus preventing the headlight from frequently malfunctioning even when the gas-discharge lamp is repeatedly used for a lengthy period of time.

Although the preferred embodiments of the present invention have been disclosed for illustrative purposes, those skilled in the art will appreciate that, various modifications, additions and substitutions are possible, without departing from the scope and spirit of the invention as disclosed in the accompanying claims.

What is claimed is:

1. A vehicle headlight, comprising a gas-discharge lamp including a bobbin and a bulb axially provided at a front end of the bobbin, a hemispherical reflecting mirror arranged to surround a rear portion of the bulb and reflecting light beams forwards, a housing installed at a center portion of the hemispherical reflecting mirror in such a way that the bobbin of the gas-discharge lamp is provided in the housing to be slidable in an axial direction, and lamp control means controlling a position of the bobbin in the housing to selectively operate a low beam mode or a high beam mode,
wherein said lamp control means includes:
a return spring provided in the housing to elastically bias the bobbin forward;
a magnet assembly installed in a rear portion of the housing in such a way as to be adjacent to a rear end of the bobbin; and
a solenoid wound around a rear portion of the bobbin, and cooperating with the magnet assembly to move the bobbin and the bulb rearward when electric power is applied.

2. The vehicle headlight according to claim 1, wherein said magnet assembly comprises:
a ring-shaped metal cover set in the rear portion of the housing, with a packing being interposed between the metal cover and the housing;
a ring-shaped magnet attached to the metal cover by a magnetic force; and
a metal bracket attached to a rear surface of the magnet and inducing a line of magnetic force to the solenoid.

3. The vehicle headlight according to claim 2, wherein said metal bracket comprises:
a disc-shaped base part attached to the rear surface of the metal cover; and
a magnetic force line inducing part forwardly projected from a center portion of the base part in such a way as to be spaced apart from an inner wall of the ring-shaped magnet at a regular interval, with a hollow part being axially formed in the magnetic force line inducing part so that power supply wires pass through the hollow part of the magnetic force line inducing part.

4. The vehicle headlight according to claim 2, wherein
said magnet is arranged to be exposed at a rear portion thereof to the outside of the housing, and
a dust cover made of rubber covers the rear portion of the magnet and the metal bracket, thus preventing impurities from penetrating into the headlight.

5. The vehicle headlight according to claim 4, wherein said dust cover comprises:
a ring-shaped cover frame surrounding an outer surface of the rear portion of the magnet; and
an elastic cover part integrated with said cover frame to have elasticity, said elastic cover part covering the metal bracket, with a wire passing hole formed at the cover part to correspond to the hollow part of the metal bracket.
